(19) United States
(12) Patent Application Publication
(10) Pub. No.: US 2026/0328283 A1
(43) Pub. Date: Oct. 22, 2026

(54) JOURNAL BEARING SHAFT FOR PLANETARY GEARBOX

(71) Applicant: THE TIMKEN COMPANY, North Canton, OH (US)

(72) Inventor: Pixiang Lan, North Canton, OH (US)

(21) Appl. No.: 19/491,125

(22) PCT Filed: May 6, 2024
(86) PCT No.: PCT/US2024/028053

§ 371 Date: Dec. 8, 2025

Related U.S. Application Data
(60) Provisional application No. 63/511,005, filed on Jun. 29, 2023.

(51) Int. Cl. F16H 57/04; F16C 17/02; F16C 33/10; F16H 57/08

(52) U.S. Cl. CPC F16H 57/0479; F16C 17/02; F16C 33/1065; F16H 57/043; F16H 57/0471; F16C 2204/10; F16C 2204/20; F16C 2208/36; F16C 2208/40; F16C 2360/31; F16C 2361/61; F16H 2057/085

(57) ABSTRACT

A journal bearing shaft assembly includes a shaft pin, first bearing insert, and second bearing insert. The shaft pin includes a length, generally circular perimeter, outer surface, oil supply groove, first bearing groove, and second bearing groove. The generally circular perimeter is defined by the outer surface in a plane perpendicular to the length. The oil supply groove extends longitudinally along a majority of the length and interrupts the generally circular perimeter. The first bearing groove extends longitudinally along a majority of the length and interrupts the generally circular perimeter at a first circumferential location. The second bearing groove extends longitudinally along a majority of the length and interrupts the generally circular perimeter at a second circumferential location. The second circumferential location is diametrically opposed to the first circumferential location. The first bearing insert is in the first bearing groove. The second bearing insert is in the second bearing groove.

### CROSS-REFERENCE TO RELATED APPLICATIONS

The present application claims priority to U.S. Provisional Application No. 63/511,005, filed Jun. 29, 2023, the entire contents of which are incorporated by reference herein.

### BACKGROUND

Wind power turbines commonly utilize planetary gear mechanisms. The planet gears in the planetary gear mechanisms rotate on shaft pins. The bearing in between a planet gear and the respective shaft pin can be a journal bearing or a roller element bearing. To gain higher power density and reduce production and maintenance costs, manufacturers of wind power turbines are moving away from roller element bearings and toward journal and thrust bearings for the planetary gear mechanisms.

### SUMMARY

In one aspect, embodiments disclosed herein relate to a journal bearing shaft assembly including a shaft pin, a first bearing insert, and a second bearing insert. The shaft pin includes a length, a generally circular perimeter, an outer surface, an oil supply groove, a first bearing groove, and a second bearing groove. The generally circular perimeter is defined by the outer surface of the shaft pin in a plane perpendicular to the length. The oil supply groove is defined in the shaft pin and delivers oil to the outer surface of the shaft pin. The oil supply groove extends longitudinally along a majority of the length of the shaft pin and interrupts the generally circular perimeter of the shaft pin. The first bearing groove is defined in the shaft pin and extends longitudinally along a majority of the length of the shaft pin. The first bearing groove interrupts the generally circular perimeter of the shaft pin at a first circumferential location. The second bearing groove is defined in the shaft pin and extends longitudinally along a majority of the length of the shaft pin. The second bearing groove interrupts the generally circular perimeter of the shaft pin at a second circumferential location. The second circumferential location is diametrically opposed to the first circumferential location. The first bearing insert is disposed in the first bearing groove. The second bearing insert is disposed in the second bearing groove.

In another aspect, embodiments disclosed herein relate to a journal bearing shaft assembly including a shaft pin, a first bearing insert, a second bearing insert, a third bearing insert, and a fourth bearing insert. The shaft pin includes a first generally circular perimeter, an outer surface, a second generally circular perimeter, an oil supply groove, a first bearing groove, a second bearing groove, a third bearing groove, and a fourth bearing groove. The first generally circular perimeter is defined by the outer surface of the shaft pin in a first plane perpendicular to the length. The second generally circular perimeter is defined by the outer surface of the shaft pin in a second plane perpendicular to the length. The second plane is spaced apart from the first plane. The oil supply groove is defined in the shaft pin and delivers oil to the outer surface of the shaft pin. The oil supply groove extends longitudinally along the shaft pin and interrupts the first and second generally circular perimeters of the shaft pin. The first bearing groove is defined in the shaft pin and extends longitudinally along the shaft pin. The first bearing groove interrupts the first generally circular perimeter of the shaft pin at a first circumferential location. The second bearing groove is defined in the shaft pin and extends longitudinally along the shaft pin. The second bearing groove interrupts the first generally circular perimeter of the shaft pin at a second circumferential location. The second circumferential location is diametrically opposed to the first circumferential location. The third bearing groove is defined in the shaft pin and extends longitudinally along the shaft pin. The third bearing groove interrupts the second generally circular perimeter of the shaft pin at a third circumferential location. The fourth bearing groove is defined in the shaft pin and extends longitudinally along the shaft pin. The fourth bearing groove interrupts the second generally circular perimeter of the shaft pin at a fourth circumferential location. The fourth circumferential location is diametrically opposed to the third circumferential location. The first bearing insert is disposed in the first bearing groove. The second bearing insert is disposed in the second bearing groove. The third bearing insert is disposed in the third bearing groove. The fourth bearing insert is disposed in the fourth bearing groove.

In yet another aspect, embodiments disclosed herein relate to a journal bearing shaft assembly including a shaft pin, an oleophobic coating, and an oleophilic coating. The shaft pin includes a length, a generally circular perimeter, an outer surface, and an oil supply groove. The generally circular perimeter is defined by the outer surface of the shaft pin in a plane perpendicular to the length. The oil supply groove is defined in the shaft pin and delivers oil to the outer surface of the shaft pin. The oil supply groove extends longitudinally along a majority of the length of the shaft pin and interrupts the generally circular perimeter of the shaft pin. The oleophobic coating is disposed on a portion of the generally circular perimeter. The oleophilic coating is disposed on a remainder of the generally circular perimeter not occupied by the oil supply groove or the oleophobic coating.

Other aspects of the disclosure will become apparent by consideration of the detailed description and accompanying drawings.

### BRIEF DESCRIPTION OF THE DRAWINGS

FIG. 1 illustrates a cross-sectional front elevation view of a planetary gear box.

FIG. 2 illustrates a schematic representation of a shaft pin surrounded by a planet gear and experiencing typical loading conditions.

FIG. 3 illustrates a map plotting oil film thickness on a chart of angle about the shaft pin versus axial position on the shaft pin for only a radial load on the shaft pin.

FIG. 4 illustrates a map plotting oil film thickness on a chart of angle about the shaft pin versus axial position on the shaft pin for a radial load and an overturn torque on the shaft pin.

FIG. 5 illustrates a perspective view of a journal bearing shaft assembly, according to embodiments disclosed herein.

FIG. 6 illustrates an exploded perspective view of the journal bearing shaft assembly of FIG. 5.

FIG. 7 illustrates a schematic front elevation view of the shaft pin of FIG. 6.

FIG. 8 illustrates a perspective view of a journal bearing shaft assembly, according to embodiments disclosed herein.

FIG. 9 illustrates an exploded perspective view of the journal bearing shaft assembly of FIG. 8.

FIG. 10 illustrates a schematic front elevation view of the shaft pin of FIG. 9.

FIG. 11 illustrates a schematic cross-sectional front elevation view of the shaft pin of FIG. 9 taken through the second plane.

FIG. 12 illustrates a schematic cross-sectional elevation view of a journal bearing shaft assembly, according to embodiments disclosed herein.

### DETAILED DESCRIPTION

Before any embodiments are explained in detail, it is to be understood that the invention is not limited in its application to the details of construction and the arrangement of components set forth in the following description or illustrated in the following drawings. The invention is capable of other embodiments and of being practiced or of being carried out in various ways.

When journal bearings are applied between a planet gear and the respective shaft pin, the bearing surface is prone to wear due to boundary and mixed lubrication conditions due to high load and low sliding speed. Some embodiments of the disclosure seek to increase journal bearing wear resistance and/or improve the hydrodynamic performance of the journal bearings.

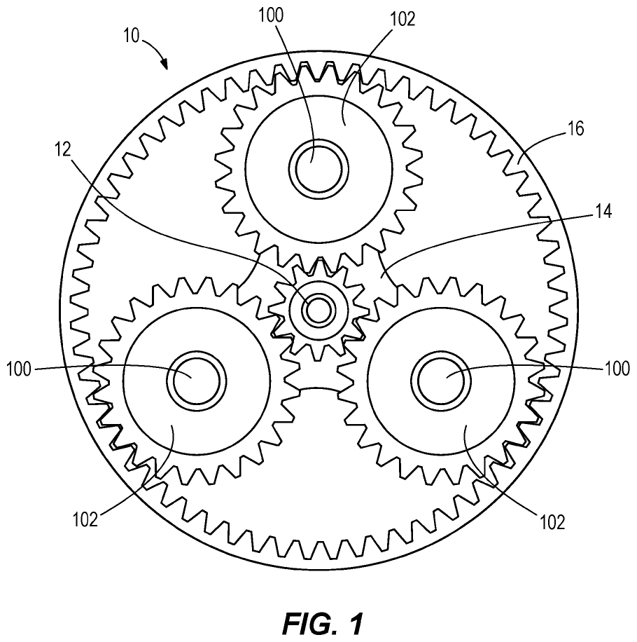

With reference to FIG. 1, a planetary gear box 10 is shown. The planetary gear box includes a sun gear 12. A carrier 14 includes a plurality of shaft pins 100 coupled thereto. Each shaft pin 100 supports a respective planet gear 102 such that the planet gears 102 surround the sun gear 12. The planet gears 102 engage the sun gear 12 as well as a surrounding ring gear 16.

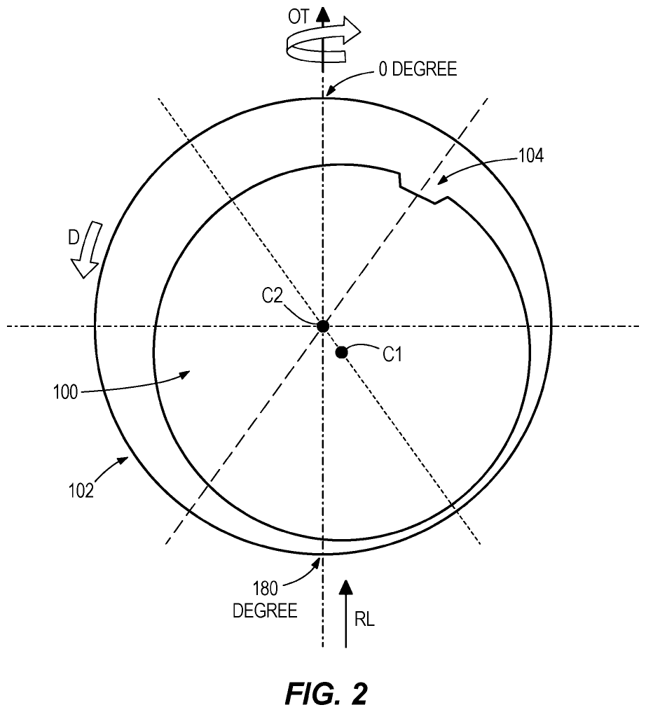

Turning now to FIG. 2, a representative shaft pin 100 surrounded by a planet gear 102 and experiencing the typical loading conditions is illustrated. In some embodiments, each shaft pin 100 of the planetary gearbox 10 experiences similar loading conditions as the planet gears 102 (and respective shaft pins 100) travel about the sun gear 12. The planet gear 102 rotates about the shaft pin 100 in a counter-clockwise direction D. The shaft pin 100 remains static relative to the carrier 14 in some embodiments. The shaft pin 100 carries a radial load RL. In embodiments utilizing a helical planet gear, an overturn torque OT is also present. The shaft pin 100 is off-center with regard to the planet gear 102. Stated another way, the shaft pin centroid C1 is spaced apart from the planet gear centroid C2. An oil supply groove 104 is defined in the shaft pin 100 for supplying oil to the interface between the shaft pin 100 and the planet gear 102. As shown in FIG. 2, for purposes of explanation throughout this disclosure, top-dead-center is considered the 0° position and bottom-dead-center is considered the 180° location. This arrangement is only an example, however. The angles and angle ranges mentioned throughout this disclosure are meant to designate the positions of the features of the shaft pin 100 relative to the loading positions (RL and OT). Stated another way, the 0° position can be any circumferential location on the shaft pin 100 that is opposite to the RL location (e.g., 180° from the RL loading location). The angle value in degrees of any position about the shaft pin 100 increases in the counter-clockwise direction of the view of FIG. 2, which is the same to the rotational direction D of the rotation of the planet gear 102 about the shaft pin 100. The shaft pin 100 is carried by a planet carrier, which carries multiple planetary gear assemblies (each including a shaft pin 100 and a planet gear 102).

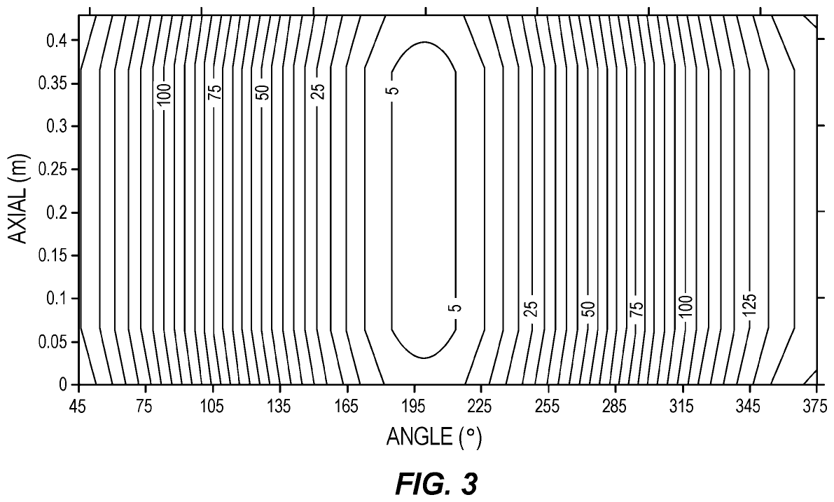

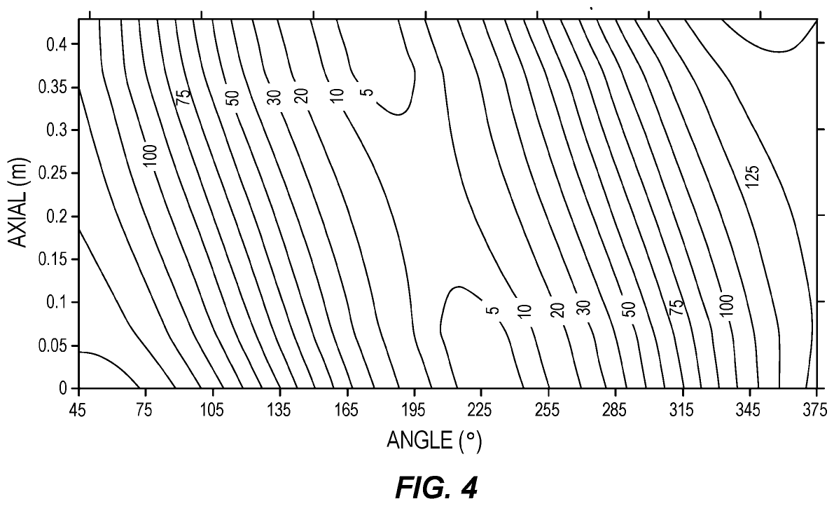

FIGS. 3 and 4 plot the oil film thickness on a chart displaying an angle about the shaft pin (in degrees) versus an axial position on the shaft pin (in meters). Both charts are the result of calculating the oil film thickness with a numerical method utilizing the Navier-Stokes equation. FIG. 3 plots the oil film thickness under only a radial load. With only a radial load, the oil film thickness can be seen to be very uniform along the axial direction. The minimum oil film thickness (e.g., less than 5 microns) is concentrated at a section of the circular angle. The simulated shaft pin experiences the minimum oil film thickness in a section from about 180° to about 210°.

FIG. 4 plots the oil film thickness under both a radial load and an overturn torque. When the overturn torque is added to the radial load, the oil film thickness map is twisted with two edge minimum oil film thickness zones on two sides. One zone is in a section from about 160° to about 195°, and the other zone is in a section from about 210° to about 245°.

Both FIGS. 3 and 4 show the oil film thickness results with normal sliding speed conditions. For the shaft pin 100 under realistic conditions, however, wear is prone to occur during start conditions and during stop conditions. During these start and stop conditions, the surfaces slide past each other at a relatively very slow speed compared to the normal sliding speed conditions. The sliding surfaces contact each other in a boundary and mixed lubrication regime. As a result, the coverage of the wear areas during start and stop conditions will be smaller compared to the minimum oil film thickness areas observed in the numerical method at normal sliding speeds.

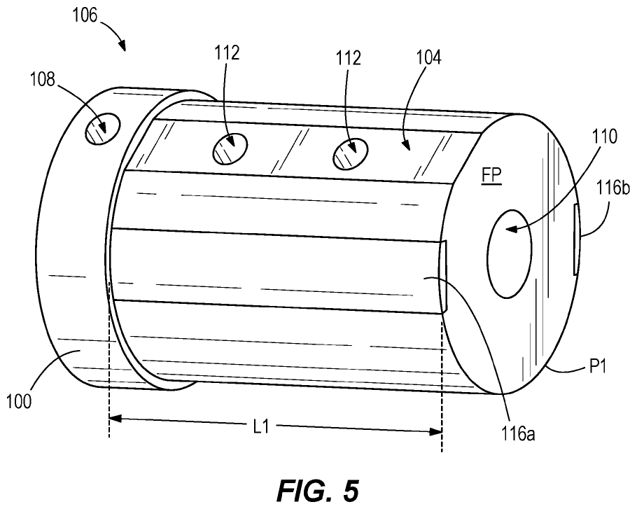

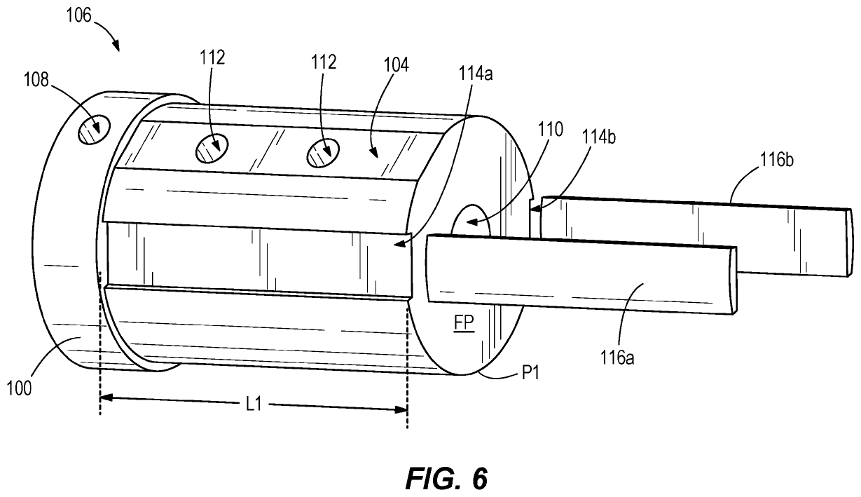

Turning now to FIGS. 5 and 6, an embodiment of a journal bearing shaft assembly 106 is shown. The journal bearing shaft assembly 106 includes the shaft pin 100, which is configured to be received in the bore of the planet gear 102. The shaft pin 100 includes a reduced diameter portion having a length L1 (or a planet gear engagement length) and a first generally circular perimeter P1 defined by an outer surface of the shaft pin 100 in a first plane FP perpendicular to the length L1. For ease of reference, the first plane FP is shown as an end of the shaft pin 100, although the first plane FP can be located elsewhere along the length L1 of the shaft pin 100. The reduced diameter portion (or the portion having a planet gear engagement length) of the shaft pin 100 is the portion of the shaft pin 100 capable of being received in the bore of the planet gear 102, while the remainder of the shaft pin 100 is disposed outside of the bore of the planet gear 102.

The shaft pin 100 further includes the remainder portion having a diameter greater than the reduced diameter portion discussed above. Defined in the larger remainder portion, an oil receiving passage 108 is configured to receive oil from, for instance, an oil pump. The oil receiving passage 108 is in fluid communication with a downstream oil reservoir 110 defined in the shaft pin 100. Oil supply passages 112 are defined in the shaft pin 100 and receive oil from the oil reservoir 110. The oil supply passages 112 are in fluid communication with the downstream oil supply groove 104 defined in the shaft pin 100. The oil supply groove 104 is formed as a truncated portion of the first generally circular perimeter P1 of the outer surface of the shaft pin 100 in a plane (such as the first plane FP, for instance) perpendicular to the length L1 of the shaft pin 100. Stated another way, the oil supply groove 104 interrupts the first generally circular perimeter P1 of the shaft pin 100. In the illustrated embodiment, the oil supply groove 104 includes a rectangular planar surface that is milled into the shaft pin 100. The oil supply passages 112 extend through this planar surface of the oil supply groove 104. The oil supply groove 104 extends longitudinally along a majority of the length L1 of the shaft pin 100.

Turning to FIG. 6, the shaft pin 100 also includes first and second bearing grooves 114a, 114b defined therein. Each of the first and second bearing grooves 114a, 114b extends longitudinally along a majority of the length L1 of the shaft pin 100 and interrupts the generally circular perimeter P1 of the shaft pin 100. The first bearing groove 114a interrupts the generally circular perimeter P1 at a first circumferential location, and the second bearing groove 114b interrupts the generally circular perimeter P1 at a second circumferential location. In the illustrated embodiment, the first and second circumferential locations (and, therefore, the first and second bearing grooves 114a, 114b) are diametrically opposed to each other (e.g., on opposite sides of the generally circular perimeter P1). The generally circular perimeter Pl would be completely circular if not for the oil supply groove 104, the first bearing groove 114a, and the second bearing groove 114b.

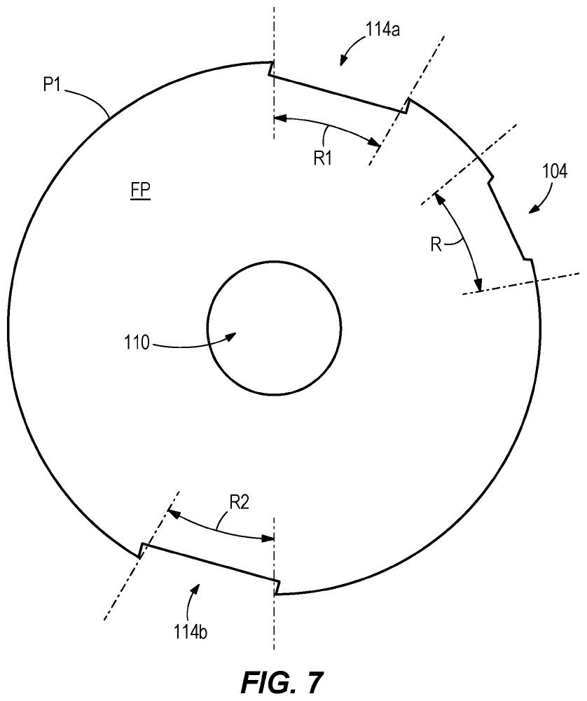

With reference to FIG. 7, some embodiments include the oil supply groove 104 interrupting the generally circular perimeter P1 of the shaft pin 100 at an oil supply location that is disposed in a circumferential range R between 300° and 350°. In further embodiments, the oil supply location of the oil supply groove 104 is centered at 325°. In some embodiments, the oil supply groove 104 may have a width of 10° (as shown in FIGS. 7), 20°, 30°, or the like. As shown in FIG. 2, however, the oil supply groove 104 may be in other appropriate locations.

With continued reference to FIG. 7, the first circumferential location of the first bearing groove 114a is disposed in a circumferential range R1 between 330° and 360°. In further embodiments, the first circumferential location is centered at 345°. The first bearing groove 114a may have a width of 20°, 30° (as shown in FIG. 7), 40°, or the like. The location of the first bearing groove 114a is chosen to correspond with a portion of the shaft pin 100 that is most prone to wear while the shaft pin 100 rotates in the primary direction (such as the angles corresponding to the minimum oil film thickness in FIG. 3).

In some embodiments, the second circumferential location of the second bearing groove 114b is disposed in a circumferential range R2 between 150° and 180°. In further embodiments, the second circumferential location is centered at 165°. The second bearing groove 114b may have a width of 20°, 30° (as shown in FIGS. 7), 40°, or the like. The location of the second bearing groove 114b is chosen to correspond with a portion of the shaft pin 100 that is most prone to wear while the shaft pin 100 rotates in a reverse direction (e.g., a rotation direction opposite that of the primary direction). The portion of the shaft pin 100 most prone to wear in the reverse direction may be, for instance, 180° from the angles corresponding to the minimum oil film thickness in FIG. 3 for the primary direction.

With reference to FIG. 5, the shaft pin 100 further includes first and second bearing inserts 116a, 116b. The first bearing insert 116a is disposed in the first bearing groove 114a, and the second bearing insert 116b is disposed in the second bearing groove 114b. In the illustrated embodiment, each bearing insert 116a, 116b forms a dovetail interface with the respective bearing groove 114a, 114b (the dovetail portion of the bearing grooves 114a, 114b shown in FIG. 7) to ensure the bearing inserts 116a, 116b are properly secured to the shaft pin 100. One or more fasteners (e.g., screws, bolts clips, pins, adhesives, welds, or the like) may be utilized to further secure the bearing inserts 216a, 216b in the respective bearing grooves 214a, 214b. The bearing inserts 116a, 116b may be made from a variety of materials including, for instance, copper, aluminum, bronze, a polymer composite (e.g., polyimide-based plastic, polyether ether ketone), or the like. In some embodiments, the first and second bearing inserts 116a, 116b are made of the same materials, but other embodiments may include the first and second bearing inserts 116a, 116b made of different materials. In the illustrated embodiment, the first and second bearing inserts 116a, 116b and, therefore, the first and second bearing grooves 114a, 114b are identical. The bearing inserts 116a, 116b may be removable for ease of replacement in case the bearing inserts 116a, 116b have suffered from wear or other damage.

The above embodiments of the journal bearing shaft assembly 106 may be suitable for conditions including only radial load RL or including radial load RL and small amounts of overturn torque OT.

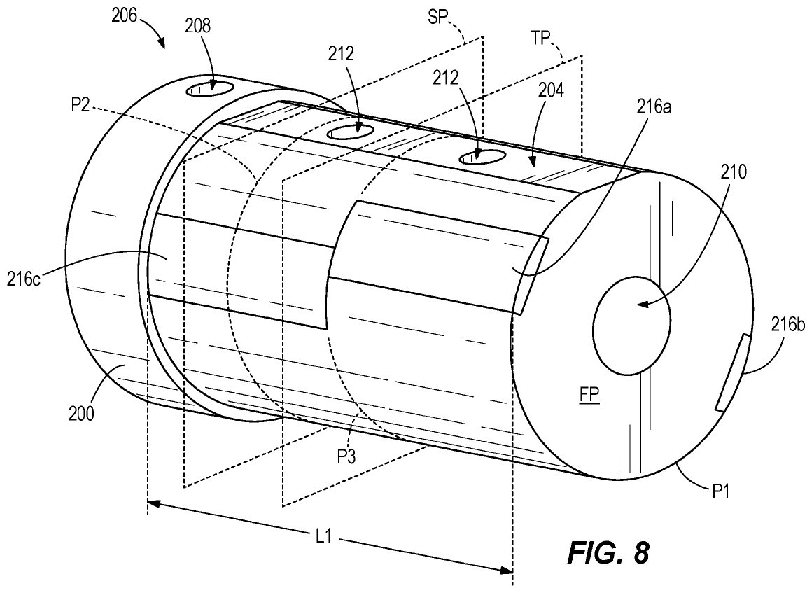

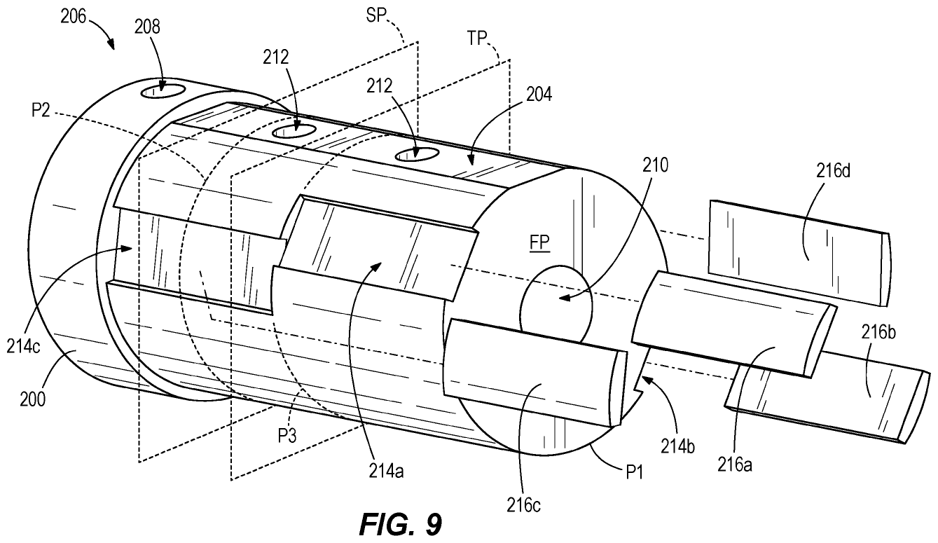

Turning now to FIGS. 8 and 9, another embodiment of a journal bearing shaft assembly 206 is shown. Components of the journal bearing shaft assembly 206 below that are similar or the same as the corresponding components of the journal bearing shaft assembly 106 discussed above are numbered the same but with a value of one hundred higher. For the sake of brevity, only the differences between the journal bearing shaft assemblies 106, 206 will be discussed below.

In addition to the first generally circular perimeter P1, the shaft pin 200 includes a second generally circular perimeter P2 defined by the outer surface of the shaft pin 200 in a second plane SP perpendicular to the length L1 of the shaft pin 200. The second plane SP is spaced apart from the first plane FP. The oil supply groove 204 extends along a majority of the length L1 of the shaft pin 200 and interrupts both the first and second generally circular perimeters P1, P2 of the shaft pin 200.

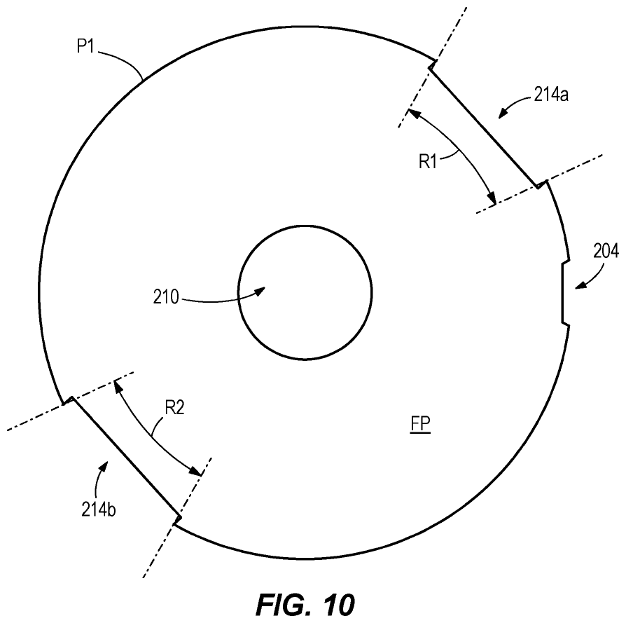

The first bearing groove 214a is defined in the shaft pin 200 and extends longitudinally along the length L1 of the shaft pin 200, interrupting the first generally circular perimeter P1 at a first circumferential location. With reference to FIG. 10, the first circumferential location of the first bearing groove 214a is disposed in a circumferential range R1 between 30° and 65°. In further embodiments, the first circumferential location is centered at 357.5°. The first bearing groove 214a may have a width of 20°, 30°, 40°, or the like. The location of the first bearing groove 214a is chosen to correspond with a first portion of the shaft pin 200 that is most prone to wear while the shaft pin 200 rotates in the primary direction (such as a first section of the angles corresponding to the minimum oil film thickness in FIG. 4). As shown in FIG. 9, the first bearing groove 214a extends along half of the length L1 of the shaft pin 200, although some embodiments may include the first bearing groove 214a extending more or less than half of the length L1 of the shaft pin 200.

The second bearing groove 214b is defined in the shaft pin 200 and extends longitudinally along the length L1 of the shaft pin 200, interrupting the first generally circular perimeter P1 at a second circumferential location. In the illustrated embodiment shown in FIG. 10, the first and second circumferential locations (and, therefore, the first and second bearing grooves 214a, 214b) are diametrically opposed to each other (e.g., on opposite sides of the first generally circular perimeter P1). In some embodiments, the second circumferential location of the second bearing groove 214 b is disposed in a circumferential range R2 between 210° and 245°. In further embodiments, the second circumferential location is centered at 177.5°. The second bearing groove 214b may have a width of 20°, 30°, 40°, or the like. The location of the second bearing groove 214b is chosen to correspond with a portion of the shaft pin 200 that is most prone to wear while the shaft pin 200 rotates in a reverse direction (e.g., a rotation direction opposite that of the primary direction). The portion of the shaft pin 200 most prone to wear in the reverse direction may be, for instance, 180° from the first section of the angles corresponding to the minimum oil film thickness in FIG. 4 for the primary direction. As shown in FIG. 9, the second bearing groove 214b extends along half of the length L1 of the shaft pin 200, although some embodiments may include the second bearing groove 214b extending more or less than half of the length L1 of the shaft pin 200.

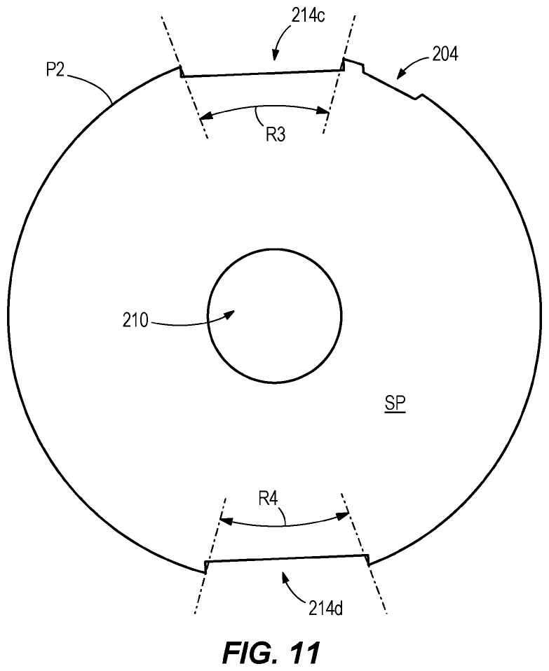

The shaft pin 200 further includes a third bearing groove 214c defined therein that extends longitudinally along the length L1 of the shaft pin 200, interrupting the second generally circular perimeter P2 at a third circumferential location. In some embodiments, the third circumferential location of the third bearing groove 214c is circumferentially offset relative to the first circumferential location of the first bearing groove 214a. With reference to FIG. 11, the third circumferential location of the third bearing groove 214c is disposed in a third circumferential range R3 between 340° and 15°. In further embodiments, the third circumferential location is centered at 47.5°. The third bearing groove 214c may have a width of 20°, 30°, 40°, or the like. In the illustrated embodiment (FIG. 9), the third bearing groove 214 c meets the first bearing groove 214a at a third plane TP disposed between and parallel to the first plane FP and the second plane SP. At this third plane TP, the third bearing groove 214c and the first bearing groove 214a at least partially overlap each other. Some embodiments include less than half of a width of the third bearing groove 214c overlapping with less than half of a width of the first bearing groove 214a, but other embodiments may include half or more than half overlapping. The location of the third bearing groove 214c is chosen to correspond with a second portion of the shaft pin 200 that is most prone to wear while the shaft pin 200 rotates in the reverse direction with a rotation direction opposite that of the primary direction (such as 180° from the second section of the angles corresponding to the minimum oil film thickness in FIG. 4). As shown in FIG. 9, the third bearing groove 214c extends along half of the length LI of the shaft pin 200, although some embodiments may include the third bearing groove 214c extending more or less than half of the length L1 of the shaft pin 200.

The shaft pin 200 also includes a fourth bearing groove 214c defined therein that extends longitudinally along the length LI of the shaft pin 200, interrupting the second generally circular perimeter P2 at a fourth circumferential location. In some embodiments, the fourth circumferential location of the fourth bearing groove 214d is circumferentially offset relative to the second circumferential location of the second bearing groove 214b. As shown in FIG. 11, the third and fourth circumferential locations (and, therefore, the third and fourth bearing grooves 214c, 214d) are diametrically opposed to each other (e.g., on opposite sides of the second generally circular perimeter P2). In some embodiments, the fourth circumferential location of the fourth bearing groove 214d is between 160° and 195°. In further embodiments, the fourth circumferential location is centered at 227.5°. The fourth bearing groove 214d may have a width of 20°, 30°, 40°, or the like. As shown in FIG. 9, the fourth bearing groove 214d meets the second bearing groove 214b at the third plane TP. At this third plane TP, the fourth bearing groove 214d and the second bearing groove 214b at least partially overlap each other. Some embodiments include less than half of a width of the fourth bearing groove 214d overlapping with less than half of a width of the second bearing groove 214b, but other embodiments may include half or more than half overlapping. The location of the fourth bearing groove 214d is chosen to correspond with a portion of the shaft pin 200 that is most prone to wear while the shaft pin 200 rotates in a primary direction. The portion of the shaft pin 200 most prone to wear in the primary direction may be, for instance, the angles corresponding to the minimum oil film thickness in FIG. 4 for the primary direction. Similar to the third bearing groove 214c, the fourth bearing groove 214d extends along half of the length L1 of the shaft pin 200, although some embodiments may include the fourth bearing groove 214d extending more or less than half of the length L1 of the shaft pin 200. The first generally circular perimeter P1 (which lies in the first plane FP) would be completely circular if not for the oil supply groove 204, the first bearing groove 214a, and the second bearing groove 214b. Similarly, the second generally circular perimeter P2 (which lies in the second plane SP) would be completely circular if not for the oil supply groove 204, the third bearing groove 214c, and the fourth bearing groove 214d. Lastly, the third generally circular perimeter P3 (which lies in the third plane TP) would be completely circular if not for the oil supply groove 204, the first bearing groove 214a, the second bearing groove 214b, the third bearing groove 214c, and the fourth bearing groove 214d.

With reference to FIG. 8, the shaft pin 200 further includes first, second, third, and fourth bearing inserts 216a, 216b, 216c, 216d. The first bearing insert 216a is disposed in the first bearing groove 214a. The second bearing insert 216b is disposed in the second bearing groove 214b. The third bearing insert 216c is disposed in the third bearing groove 214c. The fourth bearing insert 216d is disposed in the fourth bearing groove 214d. In the illustrated embodiment, each bearing insert 216a, 216b, 216c, 216d forms a dovetail interface with the respective bearing groove 214a, 214b, 214c, 214d (the dovetail portion of the bearing grooves 214a, 214b shown in FIG. 10 and the dovetail portion of the bearing grooves 214c, 214d shown in FIG. 11) to ensure the bearing inserts 216a, 216b, 216c, 216d are properly secured to the shaft pin 200. One or more fasteners (e.g., screws, bolts clips, pins, adhesives, welds, or the like) may be utilized to further secure the bearing inserts 216a, 216b, 216c, 216d in the respective bearing grooves 214a, 214b, 214c, 214d. The bearing inserts 216a, 216b, 216c, 216d may be made from a variety of materials including, for instance, copper, aluminum, bronze, a polymer composite (e.g., polyimide-based plastic, polyether ether ketone-base plastic), or the like. In some embodiments, the bearing inserts 216a, 216b, 216c, 216d are made of the same materials, but other embodiments may include the bearing inserts 216a, 216b, 216c, 216d made of different materials. Still other embodiments may include the first and second bearing inserts 216a, 216b being made of the same materials, while the third and fourth bearing inserts 216c, 216d are made of the same materials to each other but different from those of the first and second bearing inserts 216a, 216b. Yet other embodiments may include the first and third bearing inserts 216a, 216c being made of the same materials, while the second and fourth bearing inserts 216b, 216d are made of the same materials to each other but different from those of the first and third bearing inserts 216a, 216c. In the illustrated embodiment, the first and second bearing inserts 216a, 216b and, therefore, the first and second bearing grooves 214a, 214b are identical. Similarly, the third and fourth bearing inserts 216c, 216d and, therefore, the third and fourth bearing grooves 214c, 214d are identical. Some embodiments may include all the bearing inserts 216a, 216b, 216c, 216d and, therefore, the bearing grooves 214a, 214b, 214c, 214d being identical to each other in shape and materials. The bearing inserts 216a, 216b, 216c, 216d may be removable for ease of replacement in case the bearing inserts 216a, 216b, 216c, 216d have suffered from wear or other damage.

The above embodiments of the journal bearing shaft assembly 206 may be suitable for conditions including radial load RL and overturn torque OT.

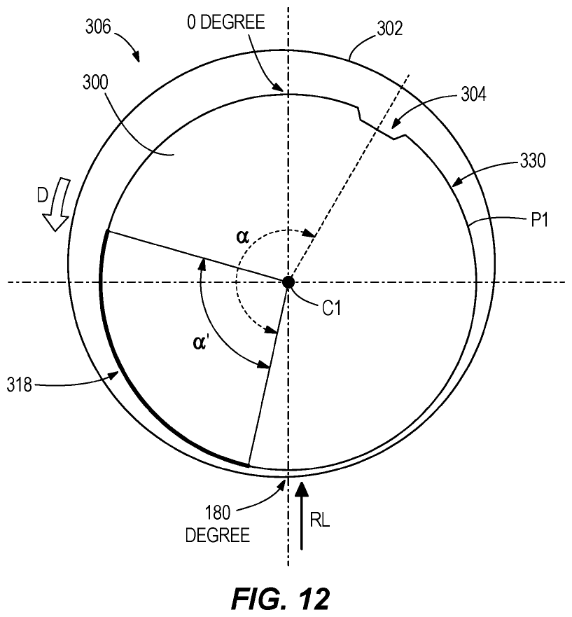

Turning now to FIG. 12, yet another embodiment of a journal bearing shaft assembly 306 is shown. Components of the journal bearing shaft assembly 306 below that are similar or the same as the corresponding components of the journal bearing shaft assembly 106 discussed above are numbered the same but with a value of two hundred higher. For the sake of brevity, only the differences between the journal bearing shaft assemblies 106, 306 will be discussed below.

The shaft pin 300 includes a generally circular perimeter P1 defined by an outer surface of the shaft pin 300 in a plane (the plane viewed in FIG. 12) perpendicular to the length L1 of the shaft pin 300. The oil supply groove 304 extends longitudinally along a majority of the length L1 and interrupting the generally circular perimeter P1 of the shaft pin 300. In the illustrated embodiment, the oil supply groove 304 interrupts the generally circular perimeter P1 at a location between 300°and 360°. The generally circular perimeter P1 would be completely circular if not for the oil supply groove 304. In some embodiments, the shaft pin 300 is made of a single homogeneous material, such as a metal.

The journal bearing shaft assembly 306 further includes an oleophobic (e.g., oil repellant) coating 318 disposed on a portion of the generally circular perimeter P1. In some embodiments, the oleophobic coating 318 (having boundary slip properties) is deposited on a converging pressure build-up section of the shaft pin 300. As shown in FIG. 12, when the planet gear 302 rotates about the shaft pin 300, due to less shear resistance from the oleophobic coating 318, more oil can be brought into the loading section. This directing of the oil can increase the load carrying capacity of the journal bearing shaft assembly 306. In some embodiments, the oleophobic coating 318 is deposited on the converging pressure build-up section of the shaft pin 300 only. The oleophobic coating 318 may start from the oil supply groove 304 and stop in the rotational direction D at an angular distance a from the oil supply groove 304. The end of the angular distance a can vary from 150° to 240°. The oleophobic coating 318 may extend circumferentially about the shaft pin 300 in the rotational direction D through an angle α′, which starts between 0° and 150° in the illustrated embodiment, and it stops in the rotational direction D at an angular distance a from the oil supply groove 304. The oleophobic coating 318 may have any appropriate thickness, but some embodiments include a thickness of less than 100 microns.

The journal bearing shaft assembly 306 also includes an oleophilic (e.g., having an oil affinity) coating 320 disposed on a portion of the generally circular perimeter P1. In some embodiments, the oleophilic coating 320 is disposed on all portions of the generally circular perimeter P1 not occupied by the oil supply groove 304 or the oleophobic coating 318. The oleophilic coating 320 may have any appropriate thickness, but some embodiments include a thickness of less than 100 microns. In some embodiments, the oleophilic coating 320 meets the oleophobic coating 318 at a circumferential location in the rotational direction D at an angular distance a from the oil supply groove 304.

The embodiments discussed above may be combined or altered in any appropriate way. It is possible, for instance, to coat one or more of the inserts 116a, 116b, 216a, 216b, 216c, 216d with either the oleophobic coating 318 or the oleophilic coating 320 in addition to or instead of coating the shaft pin 300 directly.

At least some of the embodiments described above may allow for decreased bearing machining and/or material costs, improved load and speed limits of the assembly, improved power density of the assembly, reduced creep and/or rotation issues between the shaft pin and the planet gear, and/or decreased maintenance costs.

Various features and advantages of the invention are set forth in the following claims.

What is claimed is:

1. A journal bearing shaft assembly comprising:
a shaft pin including
a planet gear engagement length and a generally circular perimeter defined by an outer surface of the shaft pin in a plane perpendicular to the planet gear engagement length,
an oil supply groove defined in the shaft pin and configured to deliver oil to the outer surface of the shaft pin, the oil supply groove extending longitudinally along a majority of the planet gear engagement length of the shaft pin and interrupting the generally circular perimeter of the shaft pin,
a first bearing groove defined in the shaft pin, the first bearing groove extending longitudinally along a majority of the planet gear engagement length of the shaft pin and interrupting the generally circular perimeter of the shaft pin at a first circumferential location, and
a second bearing groove defined in the shaft pin, the second bearing groove extending longitudinally along a majority of the planet gear engagement length of the shaft pin and interrupting the generally circular perimeter of the shaft pin at a second circumferential location, the second circumferential location being diametrically opposed to the first circumferential location;
a first bearing insert disposed in the first bearing groove; and
a second bearing insert disposed in the second bearing groove.

2. The journal bearing shaft assembly of claim 1, wherein each of the first bearing insert and the second bearing insert includes copper.

3. The journal bearing shaft assembly of claim 1, wherein each of the first bearing insert and the second bearing insert includes aluminum.

4. The journal bearing shaft assembly of claim 1, wherein each of the first bearing insert and the second bearing insert includes a polymer.

5. The journal bearing shaft assembly of claim 4, wherein the polymer includes a polyimide-based plastic.

6. The journal bearing shaft assembly of claim 4, wherein the polymer includes polyether ether ketone.

7. The journal bearing shaft assembly of claim 1, wherein the first bearing insert and the second bearing insert are removable.

8. The journal bearing shaft assembly of claim 7, wherein
the first bearing insert forms a dovetail interface with the first bearing groove, and
the second bearing insert forms a dovetail interface with the second bearing groove.

9. The journal bearing shaft assembly of claim 1, wherein
the first circumferential location is between 0° and 30°,
the oil supply groove interrupts the generally circular perimeter of the shaft pin at an oil supply location between 300° and 360°, and
the second circumferential location is between 180° and 210°.

10. The journal bearing shaft assembly of claim 9, wherein the oil supply location is centered at 330°.

11. The journal bearing shaft assembly of claim 9, wherein
the first circumferential location extends between 0° and 30°,
the oil supply location extends between 300° and 360°, and
the second circumferential location extends between 180° and 210°.

12. A journal bearing shaft assembly comprising:
a shaft pin including
a planet gear engagement length,
a first generally circular perimeter defined by an outer surface of the shaft pin in a first plane perpendicular to the planet gear engagement length,
a second generally circular perimeter defined by the outer surface of the shaft pin in a second plane perpendicular to the planet gear engagement length, the second plane spaced apart from the first plane,
an oil supply groove defined in the shaft pin and configured to deliver oil to the outer surface of the shaft pin, the oil supply groove extending longitudinally along the shaft pin and interrupting the first and second generally circular perimeters of the shaft pin,
a first bearing groove defined in the shaft pin, the first bearing groove extending longitudinally along the shaft pin and interrupting the first generally circular perimeter of the shaft pin at a first circumferential location, and
a second bearing groove defined in the shaft pin, the second bearing groove extending longitudinally along the shaft pin and interrupting the first generally circular perimeter of the shaft pin at a second circumferential location, the second circumferential location being diametrically opposed to the first circumferential location;
a third bearing groove defined in the shaft pin, the third bearing groove extending longitudinally along the shaft pin and interrupting the second generally circular perimeter of the shaft pin at a third circumferential location, and
a fourth bearing groove defined in the shaft pin, the fourth bearing groove extending longitudinally along the shaft pin and interrupting the second generally circular perimeter of the shaft pin at a fourth circumferential location, the fourth circumferential location being diametrically opposed to the third circumferential location;
a first bearing insert disposed in the first bearing groove;
a second bearing insert disposed in the second bearing groove;
a third bearing insert disposed in the third bearing groove; and
a fourth bearing insert disposed in the fourth bearing groove.

13. The journal bearing shaft assembly of claim 12, wherein
the third bearing groove is offset relative to the first bearing groove, and
the fourth bearing groove is offset relative to the second bearing groove.

14. The journal bearing shaft assembly of claim 12, wherein
the first circumferential location is between 340° and 15°,
the second circumferential location is between 160° and 195°,
the third circumferential location is between 30° and 65°, and
the fourth circumferential location is between 210° and 245°.

15. The journal bearing shaft assembly of claim 14, wherein
the first bearing groove and the third bearing groove meet at a third plane disposed between and parallel to the first plane and the second plane, and
the second bearing groove and the fourth bearing groove meet at the third plane.

16. The journal bearing shaft assembly of claim 15, wherein
less than half of the first bearing groove overlaps with less than half of the third bearing groove at the third plane, and
less than half of the second bearing groove overlaps with less than half of the fourth bearing groove at the third plane.

17. A journal bearing shaft assembly comprising:
a shaft pin including
a planet gear engagement length and a generally circular perimeter defined by an outer surface of the shaft pin in a plane perpendicular to the planet gear engagement length, and
an oil supply groove defined in the shaft pin and configured to deliver oil to the outer surface of the shaft pin, the oil supply groove extending longitudinally along a majority of the planet gear engagement length of the shaft pin and interrupting the generally circular perimeter of the shaft pin;
an oleophobic coating disposed on a portion of the generally circular perimeter; and
an oleophilic coating disposed on a remainder of the generally circular perimeter not occupied by the oil supply groove or the oleophobic coating.

18. The journal bearing shaft assembly of claim 17, wherein the shaft pin includes a single homogenous material.

19. The journal bearing shaft assembly of claim 17, wherein
the portion of the generally circular perimeter having the oleophobic coating meets the remainder of the generally circular perimeter having the oleophilic coating at a circumferential location that is between 220° and 260°, and
the oil supply groove interrupts the generally circular perimeter at a location between 310° and 50°.

20. The journal bearing shaft assembly of claim 19, wherein the portion of the generally circular perimeter having the oleophobic coating meets the remainder of the generally circular perimeter having the oleophilic coating at a circumferential location of 240°.
